(19) United States
(12) Patent Application Publication
(10) Pub. No.: US 2014/0013662 A1
(43) Pub. Date: Jan. 16, 2014

(54) COLD FRAME WITH ROOF ELEMENT

(71) Applicant: Heinrich Wüster, Imst (AT)

(72) Inventor: Heinrich Wüster, Imst (AT)

(21) Appl. No.: 13/931,510

(22) Filed: Jun. 28, 2013

(30) Foreign Application Priority Data
Jul. 16, 2012 (AT) A787/2012

(51) Int. Cl. A01G 9/24

(52) U.S. Cl. CPC A01G 9/24
USPC 47/19.2

(57) ABSTRACT

A cold frame with at least one light-permeable roof element which is arranged on the upper side of the cold frame. The roof element has an outer frame which bears a fine-mesh, light- and air-permeable lattice element which spans the interior of the cold frame. The outer frame bears, if appropriate, a window element which is arranged above the lattice element and covers the lattice element.

### BACKGROUND

1. Technical Field

The invention relates to a cold frame with at least one light-permeable roof element which is arranged on the upper side of the cold frame.

2. Description of the Related Art

In a cold frame the lateral wall elements form an upwardly and downwardly open container which stands on the soil and in the interior of which plants are arranged. The upper side of the container is covered by one or two light-permeable roof elements which can be pivoted upward. The light-permeable roof elements comprise glass plates or highly transparent hollow-chamber plates of plastic (polycarbonate).

The cold frame is built up in the spring and used until the early summer as a growth aid for the plants arranged in the cold frame. During this period, the pivoted-closed roof elements protect the interior of the cold frame during colder weather and protect the plants arranged therein from excessive cooling. With increasing external temperature and increasing solar irradiation, the roof elements are gradually pivoted upward more and more and fixed in the respective slanting position. As a result, overheating of the interior of the cold frame and of the plants arranged therein is prevented. After early summer, the roof elements are removed, or the cold frame is removed in its entirety. During the most important growth period of the plants, the cold frame remains unused. A further short use period for the cold frame occurs in the fall, when the last plants are intended to be protected from the onset of frost.

### BRIEF SUMMARY

The invention proposes a novel cold frame which has at least one light-permeable roof element which is arranged on the upper side of the cold frame. The roof element has an outer frame which bears a fine-mesh, light- and air-permeable lattice element which spans the interior of the cold frame. The outer frame bears, if appropriate, a window element which is arranged above the lattice element and covers the lattice element.

The cold frame according to the invention can be used from early spring right through until late fall. The roof element provided with a fine-mesh lattice element protects, in the pivoted-closed state, the interior of the cold frame and protects the plants arranged therein from flying pests but also from snails and slugs and crawling pests. At the same time, ventilation of the cold frame through the fine-mesh lattice element is maintained. The heat arising in the cold frame can escape upwardly through the fine-mesh lattice element. The solar rays striking the fine-mesh lattice element are scattered on the lattice element. At the same time, the fine-mesh lattice element allows natural irrigation by rain but also manual irrigation by means of a garden hose or watering can. In the event of heavy rain or hail, the fine-mesh lattice element protects the plants arranged in the cold frame from any damage. Heavy rain or hail first strikes the fine-mesh lattice element and is captured thereby without damaging the plants arranged below the lattice element. It is only for planting, weeding or harvesting that the roof element has to be pivoted upward. Over the summer, the roof element provided with a fine-mesh lattice element can remain at the upper edge of the lateral wall elements of the cold frame.

According to a further feature of the invention, the lattice element can be arranged in the interior of the frame and be supported at at least two mutually opposite legs of the frame on inwardly projecting webs.

According to a further feature of the invention, the lattice element can be arranged in the interior of the frame and be accommodated by its outer edge at at least two legs of the frame in upwardly open longitudinal grooves arranged on the inner sides of the legs.

According to a further feature of the invention, the lattice element can consist of a wire lattice formed as an insect protection screen or as a fly screen, in particular of a wire lattice of stainless steel fabric or of aluminum fabric.

According to a further feature of the invention, the lattice element can be arranged in the interior of the frame and can be designed as a flexible, fine-mesh net which is fastened to at least two legs of the frame.

According to a further feature of the invention, the flexible net can be accommodated at at least two legs of the frame in upwardly open grooves arranged on the inner sides of the legs.

According to a further feature of the invention, the flexible net can be fixedly clamped in each groove by a clamping element.

According to a further feature of the invention, it can be provided that the upwardly open grooves are designed as undercut grooves and that the flexible net is fixedly clamped in the undercut grooves by means of clamping elements which are arranged in the grooves and engage behind the undercuts of the grooves.

According to a further feature of the invention, the clamping element provided can be a profiled rod which is inserted into the groove and which is designed as an elastic clamping profile which can be compressed in the transverse direction.

According to a further feature of the invention, the flexible, fine-mesh net can consist of a, preferably coated, fiberglass fabric designed as an insect protection screen or as a fly screen.

According to a further feature of the invention, it can be provided that the roof element bears a window element which is arranged above the lattice element and can be removed from the outer frame of the roof element.

This design of the roof element allows the window element to be placed on the roof element in spring and in late fall during colder weather. At the start of the summer, the window element can be removed from the roof element and the protection of the plants is maintained by the fine-mesh, light- and air-permeable lattice element arranged in the roof element.

Depending on the external temperature and solar irradiation, the roof element provided with the placed-on window element is pivoted upward to a greater or lesser degree and fixed in the respective slanting position. With the roof element pivoted shut, the window element arranged above the lattice element retains the warm air in the cold frame.

According to a further feature of the invention, the roof element can bear a transparent plate which is arranged above the lattice element and which is inserted into longitudinal grooves arranged at the edge of the roof element.

According to a further feature of the invention, the roof element can bear a window element which is arranged above the lattice element and which is provided at two mutually opposite edges with retaining profiles which engage around the legs of the outer frame of the roof element.

According to a further feature of the invention, the roof element can bear a window element which is arranged above the lattice element and which is provided with a frame which can be plugged from above onto the outer frame of the roof element.

According to a further feature of the invention, the frame of the window element can bear on the underside two vertical locating pins which are accommodated in vertical holes at the outer frame of the roof element.

According to the invention, the window element arranged above the lattice element can comprise a glass plate or a highly transparent hollow-chamber plate of plastic.

The invention will be explained in more detail below with reference to exemplary embodiments.

### BRIEF DESCRIPTION OF THE SEVERAL VIEWS OF THE DRAWINGS

In the drawings:

FIG. 1 shows a first cold frame in an oblique view,

FIG. 2 shows a second cold frame in an oblique view,

FIG. 3 shows a third cold frame in an oblique view,

FIG. 4 shows a first roof element in plan view,

FIG. 5 shows a second roof element in cross section,

FIG. 6 shows the roof element of FIG. 5 in longitudinal section,

FIG. 7 shows a third roof element in cross section,

FIG. 8 shows a fourth roof element in cross section,

FIG. 9 shows a frame leg of a roof element frame in cross section, and

FIG. 10 shows a profiled rod in cross section.

### DETAILED DESCRIPTION

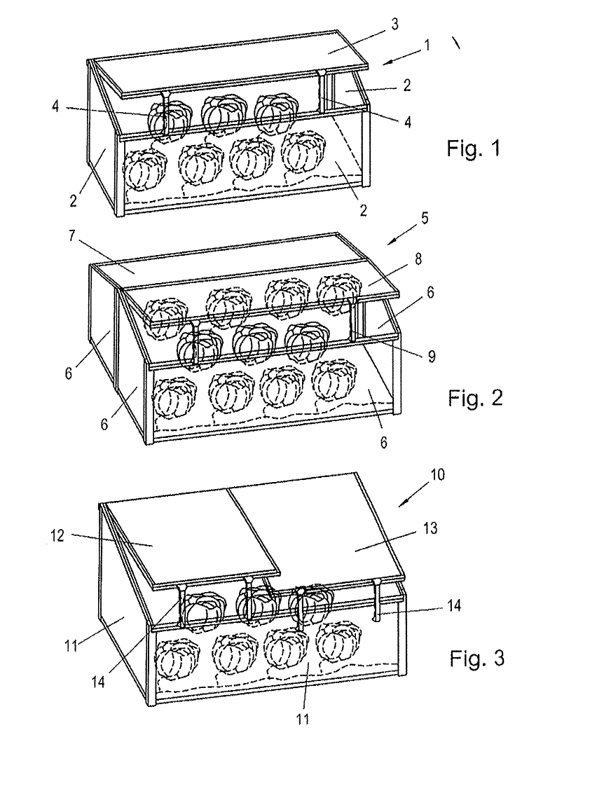

FIG. 1 shows a cold frame 1 occupied with plants and having a single-pitched Roof. The cold frame 1 has a rectangular cold frame box which is composed of four wall elements 2 and which is seated on the soil with the open underside. A pivotable roof element 3 is arranged at the open upper side of the cold frame box. FIG. 1 shows a slightly opened cold frame 1 with a slanting roof element 3 which is supported via two adjustable ventilation levers 4 on the upper edge of the front wall of the cold frame box.

FIG. 2 shows a further cold frame 5 occupied with plants and having a double-pitched roof. The cold frame 5 has a rectangular cold frame box which is composed of six wall elements 6 and which is seated with the open underside on the soil and bears, on the open upper side, a double-pitched roof consisting of two pivotable roof elements 7. FIG. 2 shows a slightly opened cold frame 5 with a slanting front roof element 8 which is supported via two adjustable ventilation levers 9 on the upper edge of the front wall of the cold frame box.

FIG. 3 shows a further cold frame 10 occupied with plants and having a single-pitched roof. The cold frame 10 has a rectangular cold frame box which is composed of four wall elements 11 and which is seated with the open underside on the soil and bears, on the open upper side, two roof elements 12, 13 arranged next to one another. FIG. 3 shows a slightly opened cold frame 10 with two slanting roof elements 12, 13 which are each supported via two adjustable ventilation levers 14 on the upper edge of the front wall of the cold frame box.

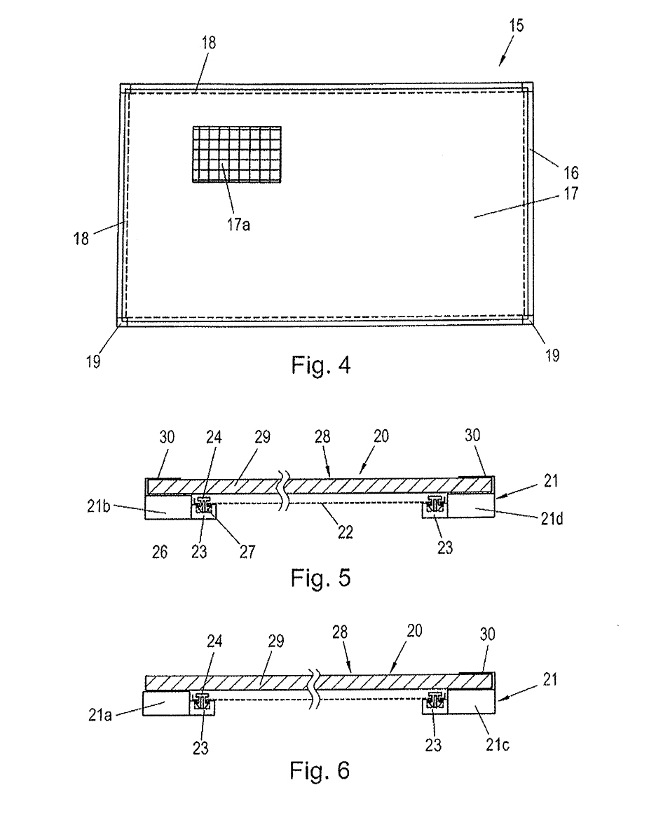

FIG. 4 shows a novel light-permeable roof element 15 for the cold frames 1, 5, 10 of FIGS. 1, 2, 3. The roof element 15 provides an outer, rectangular frame 16 which bears a fine-mesh, light- and air-permeable lattice element 17 which is arranged in the interior of said frame and which is supported by its outer edge on webs 18 projecting inwardly from the frame 16. In the cold frame 1, 5, 10 of FIGS. 1, 2, 3 the lattice element 17 covers the interior of the cold frame. The lattice structure of the lattice element 17 is represented schematically in somewhat enlarged form in the detail 17a in FIG. 4. The frame 16 provides four legs which are connected to one another at the corners of the frame 16 by corner pieces 19 and from which the webs 18 on which the lattice element 17 is supported project laterally. The lattice element 17 is fixed to the webs 18, for example, by means of hot-melt adhesive. For the lattice element 17 there is provided a lattice which is a wire lattice designed as an insect protection screen or as a fly screen and which consists of a stainless steel fabric or of an aluminum fabric.

The lattice element 17, which covers the interior of the frame 16, can have a thickened, outer edge which is adjacent to the frame 16 and by which the lattice element 17 is accommodated in upwardly open longitudinal grooves of the frame 16, which grooves are arranged at two mutually opposite legs of the frame 16 on the inner sides of the legs.

FIGS. 5 and 6 show a further novel roof element 20 for the cold frames 1, 5, 10 of FIGS. 1, 2, 3.

The roof element 20 has an outer, rectangular frame 21 with four legs 21a to 21d connected to one another at the corners of the frame 21. FIG. 5 shows the two lateral frame legs 21b and 21d. FIG. 6 shows the front frame leg 21a and the rear frame leg 21c.

The frame 21 bears a light- and air-permeable lattice element 22 which is formed by a flexible, fine-mesh net and which spans the interior of the frame 21 and is fastened to the legs of the frame 21. In the cold frame 1, 5, 10 of FIGS. 1, 2, 3, the lattice element 22 covers the interior of the cold frame.

The flexible net is accommodated at the four legs 21a to 21d of the frame 21 in upwardly open longitudinal grooves 23 which are arranged on the inner sides of the legs 21a to 21d. In order to secure the flexible net in the longitudinal grooves 23, a thick cord can be provided which, together with the flexible net, is pressed into the respective longitudinal groove 23 and then clamps in the flexible net between it and the longitudinal groove 23 and thereby secures the net in the longitudinal groove 23.

In the variant of the roof element represented in FIGS. 5 and 6, the upwardly open longitudinal grooves 23 are designed as undercut grooves. The flexible net is secured in the longitudinal grooves 23 by profiled rods 24 which are inserted into the longitudinal grooves 23 and which engage behind the undercuts of the longitudinal grooves 23.

The profiled rods 24 can be designed as an elastic clamping profile which can be compressed in the transverse direction. FIG. 10 shows such a profiled rod in cross section.

The profiled rod 24 has an upper strip 25 and two elastically deformable webs 26, 27 projecting downwardly therefrom. The two webs 26, 27 are arranged with a spacing next to one another and each have a thickened lower end which is beveled at the outer side of the webs 26, 27.

The profiled rod 24 is pressed with the lower ends of the webs 26, 27 leading, together with the flexible net, into a longitudinal groove 23. Here, the webs 26, 27 are elastically deformed and pressed toward one another with the lower ends. The profiled rod 24 expands in the longitudinal groove 23 and the thickened lower ends of the webs 26, 27 move apart and engage behind the undercuts of the longitudinal groove 23. Here, the flexible net is clamped in between the longitudinal groove 23 and the two webs 26, 27 of the profiled rod 24 and secured in the longitudinal groove 23.

A flexible, fine-mesh net is provided for the lattice element 22, which net is a fiberglass fabric which is designed as an insect protection screen or as a fly screen and which can be coated with plastic, for example PVC (polyvinyl chloride).

The roof element 20 provides a window element 28 which is arranged above the lattice element 22 in the outer frame 21 of the roof element 20 and covers the lattice element 22. In the cold frame 1, 5, 10 of FIGS. 1, 2, 3, the window element 28 covers—just as the lattice element 22—the interior of the cold frame 1, 5, 10.

The window element 28 provided is a transparent plate 29 which is inserted into longitudinal grooves 30 of the frame 21 which are arranged at the edge of the roof element 20, and spans the interior of the frame 21. In the frame 21, the two lateral frame legs 21b and 21d and the rear frame leg 21c are provided with longitudinal grooves 30 which are open inwardly toward the interior of the frame 21 and in which the transparent plate 29 is accommodated by its lateral edges.

The transparent plate 29 can be inserted into the roof element 20 in the spring and be withdrawn from the roof element 20 at the beginning of summer.

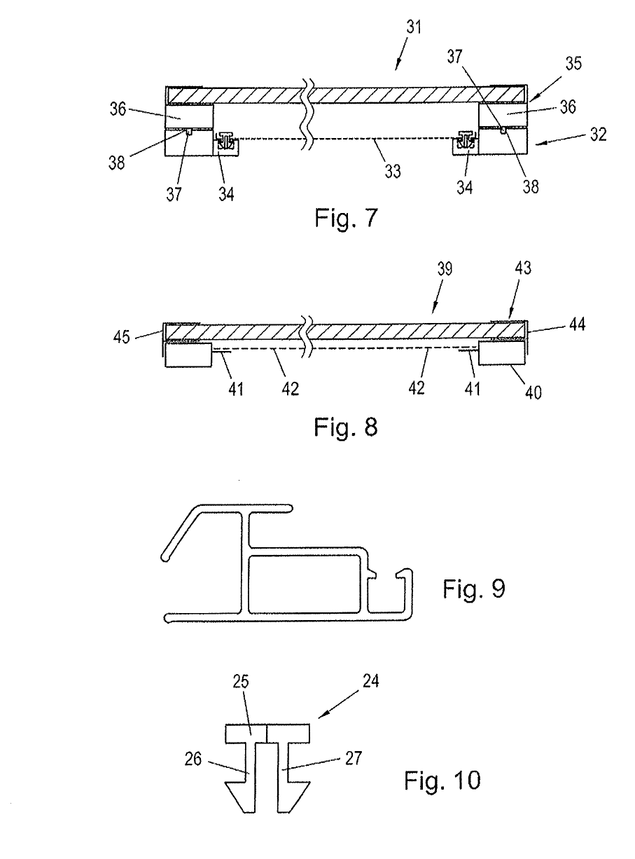

FIG. 7 shows a further novel roof element 31 for the cold frames 1, 5, 10 of FIGS. 1, 2, 3.

The roof element 31 provides an outer, rectangular frame 32 which bears a flexible, fine-mesh lattice element 33 which spans its interior. The lattice element 33 is firmly clamped on the inner sides of the frame legs in upwardly open longitudinal grooves 34. A flexible, fine-mesh net is provided for the lattice element 33, which net is a fiberglass fabric which is designed as an insect protection screen or as a fly screen and which can be coated with plastic, for example PVC (polyvinyl chloride).

The roof element 31 further provides a window element 35 which is arranged above the lattice element 33 and can be removed from the roof element 31 and which, in the cold frame 1, 5, 10 of FIGS. 1, 2, 3—just like the flexible lattice element 33—, covers the interior of the cold frame 1, 5, 10. The window element 35 has an outer, rectangular frame 36 which on the underside bears two vertical locating pins 37 which are assigned vertical holes 38 on the upper side of the roof element frame 32. The window element 35 can be placed on the roof element 31 from above in spring and can be removed upwardly from the roof element 31 at the beginning of summer.

FIG. 8 shows a further novel roof element 39 for the cold frames 1, 5, 10 of FIGS. 1, 2, 3. The roof element 39 provides an outer, rectangular frame 40 which is provided with webs 41 which project inwardly from its frame legs and on which a rigid lattice element 42 is supported, which element is fixed to the webs 41, for example, by means of a hot-melt adhesive. For the rigid lattice element 42 a lattice is provided which is a wire lattice which is designed as an insect protection screen or as a fly screen and which consists of a stainless steel fabric or of an aluminum fabric. In the cold frames 1, 5, 10 of FIGS. 1, 2, 3, the rigid lattice element 42 in each case covers the interior of the cold frame 1, 5, 10.

The roof element 39 provides a window element 43 which is arranged above the lattice element 42 and covers the lattice element 42 and which, in the cold frame 1, 5, 10 of FIGS. 1, 2, 3—just like the rigid lattice element 42—, covers the interior of the cold frame 1, 5, 10. The window element 43 is provided on two mutually opposite edges with retaining profiles 44, 45 which, in the outer frame 40 of the roof element 39, engage around two mutually opposite legs and secure the window element 43 on the roof element 39. The two retaining profiles 44, 45 have profile legs which project downwardly from the window element 43 and which, in the outer frame 40 of the roof element 39, bear on the outer side of two mutually opposite legs. The window element 43 can be plugged from above onto the outer frame 40 of the roof element 39 by means of the retaining profiles 44, 45, or be pushed on laterally.

The retaining profiles mounted on mutually opposite lateral edges of the window element 43 can also be provided with guide rails which engage around the outer side and the underside of mutually opposite legs of the outer frame 40 of the roof element 39. A window element 43 provided with such retaining profiles is pushed from the side onto the outer frame 40 of the roof element 39 and removed laterally therefrom.

The window element which can be removed from the outer frame of the roof element can comprise a glass plate or a highly transparent hollow-chamber plate of plastic (polycarbonate).

In the outer frame of the roof element which bears the fine-mesh, light- and air-permeable lattice element, the frame legs can be formed by profiles of aluminum. FIG. 9 shows such an aluminum profile in cross section. The outer frame of the roof element can also be produced from wood.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure. Aspects of the embodiments can be modified, if necessary to employ concepts of the various patents, application and publications to provide yet further embodiments.

1. A cold frame comprising at least one light-permeable roof element which is arranged on the upper side of the cold frame, the roof element having an outer frame which bears a fine-mesh, light- and air-permeable lattice element which spans the interior of the cold frame, and the outer frame bears a window element which is arranged above the lattice element and covers the lattice element.

2. A cold frame according to claim 1, wherein the lattice element is arranged in the interior of the frame and is supported at at least two mutually opposite legs of the frame on inwardly projecting webs.

3. A cold frame according to claim 1, wherein the lattice element is arranged in the interior of the frame and is accommodated by its outer edge at at least two legs of the frame in upwardly open longitudinal grooves arranged on the inner sides of the legs.

4. A cold frame according to claim 1, wherein the lattice element consists of a wire lattice formed as an insect protection screen or as a fly screen, in particular of a wire lattice of stainless steel fabric or of aluminum fabric.

5. A cold frame according to claim 1, wherein the lattice element is arranged in the interior of the frame and is designed as a flexible, fine-mesh net which is fastened to at least two legs of the frame.

6. A cold frame according to claim 5, wherein the flexible net is accommodated at at least two legs of the frame in upwardly open grooves arranged on the inner sides of the legs.

7. A cold frame according to claim 6, wherein the flexible net is fixedly clamped in each groove by a clamping element.

8. A cold frame according to claim 6, wherein the upwardly open grooves are designed as undercut grooves and in that the flexible net is fixedly clamped in the undercut grooves by means of clamping elements which are arranged in the grooves and engage behind the undercuts of the grooves.

9. A cold frame according to claim 8, wherein the clamping element provided is a profiled rod which is inserted into the groove and which is designed as an elastic clamping profile which can be compressed in the transverse direction.

10. A cold frame according to claim 5, wherein the flexible, fine-mesh net consists of a fiberglass fabric designed as an insect protection screen or as a fly screen.

11. A cold frame according to claim 1, wherein the roof element bears a window element which is arranged above the lattice element and can be removed from the outer frame of the roof element.

12. A cold frame according to claim 11, wherein the roof element bears a transparent plate which is arranged above the lattice element and which is inserted into longitudinal grooves arranged at the edge of the roof element.

13. A cold frame according to claim 11, wherein the roof element bears a window element which is arranged above the lattice element and which is provided at two mutually opposite edges with retaining profiles which engage around two mutually opposite legs of the outer frame of the roof element.

14. A cold frame according to claim 11, wherein the roof element bears a window element which is arranged above the lattice element and which is provided with a frame which can be plugged from above onto the outer frame of the roof element.

15. A cold frame according to claim 14, wherein the frame of the window element bears on the underside two vertical locating pins which are accommodated in vertical holes at the outer frame of the roof element.

16. A cold frame according to claim 11, wherein the window element arranged above the lattice element comprises a glass plate or a highly transparent hollow-chamber plate of plastic.
